(19) United States
(12) Patent Application Publication
(10) Pub. No.: US 2006/0165194 A1
(43) Pub. Date: Jul. 27, 2006

(54) Data sending device, data receiving device, and data transmission method

(76) Inventors: Yuji Mizuguchi, Hirakata (JP); Nobuhiko Yasui, Moriguchi (JP); Noboru Katta, Kawasaki (JP); Takahisa Sakai, Yokohama (JP); Yutaka Takahira, Neyagawa (JP); Hirotsugu Kawada, Osaka (JP); Toshitomo Umei, Settsu (JP); Takashi Akita, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/530,321

(22) PCT Filed: Jan. 28, 2004
(86) PCT No.: PCT/JP04/00765

§ 371 Date: Jul. 28, 2005

(51) Int. Cl. H04L 27/20

(52) U.S. Cl. 375/308

(57) ABSTRACT

The data sending device (10) receives input biphase-mark-encoded sending data which is output from an apparatus on the sending side, and a biphase decoding section (12) biphase-mark-decodes the input sending data. The output data from the biphase decoding section (12) is transmitted to a data receiving device via a sending section (14). On the other hand, the data receiving device biphase-mark-encodes the data received from the data sending apparatus (10) and then supplies the data to an apparatus on the receiving side.

### TECHNICAL FIELD

The present invention relates to a data sending device, a data receiving device and a data transmission method, and more specifically, to a data sending device, a data receiving device and a data transmission method for transmitting biphase-mark-encoded sending data.

### BACKGROUND ART

Conventionally, for transferring digital audio data between two apparatuses, biphase mark encoding is generally used as defined by, for example, the format of the S/PDIF (Sony/Philips Digital Interface). According to the biphase mark encoding, as shown in FIG. 18, each bit of original data is represented by two logical values. After the biphase mark encoding, state transition of logic “1” of the original data occurs at the center of a one-bit period (for example, 0→1 or 1→0); and state transition of logic “0” of the original data does not occur even at the center of a one-bit period (for example, 0→0 or 1→1). Moreover, at each border between bits of the original data, the logical value is necessarily inverted (i.e., after the biphase mark encoding, when the immediately previous logical value is 0, that logical value is inverted to 1; and when the immediately previous logical value is 1, that logical value is inverted to 0).

As described above, when biphase mark encoding is used, the logical value is necessarily changed at each border between bits of the original data. Therefore, even when the same logical value 0 or 1 is continued in the original data, an apparatus on the receiving side can easily recover a clock signal from the transferred data without requiring the clock signal to be separately sent.

FIG. 19 shows a frame structure according to the S/PDIF. An S/PDIF frame includes a data section and a header section, and biphase mark encoding is applied to the data section.

Recently, a communication protocol referred to as the “MOST (Media Oriented Systems Transport)” is available as a communication protocol for realizing data transfer between vehicle-mounted apparatuses using an in-vehicle LAN. With the MOST, data transfer is performed on a frame (MOST frame) by frame (MOST frame) basis. To the MOST frames also, the biphase mark encoding is applied.

FIG. 20 shows a representative structure of a conventional MOST sending and receiving device. A sending and receiving device 90 includes a MOST controller 91, an E/O converter 92, and an O/E converter 93. The MOST controller 91 receives input sending data. The MOST controller 91 performs predetermined processing and outputs a biphase-mark-encoded MOST frame to the E/O converter 92. The E/O converter 92 converts the MOST frame (electric signal) from the MOST controller 91 into an optical signal, and outputs the optical signal to another sending and receiving device via an optical fiber 94. On the other hand, the sending and receiving device 90 receives an input optical signal from another sending and receiving device via an optical fiber 95. The input optical signal is converted into an electric signal via the O/E converter 93 and is input to the MOST controller 91 as a MOST frame. The MOST controller 91 performs predetermined processing on the MOST frame and outputs receiving data.

The MOST is a ring-shaped LAN and is a communication protocol optimized for data transfer using a POF (Plastic Optical Fiber), but can also use a conductor such as a twisted pair cable or a coaxial cable as a transmission medium. An advantage of using a conductor is that the conductor is easy to handle.

Data transfer using biphase mark encoding does not need transfer of a clock signal, but requires an increased transfer band for realizing a predetermined data transfer rate. For example, as shown in FIG. 20, in order to realize an effective transfer rate of 25 Mbps, the MOST requires a data transfer rate of 50 Mbps. Accordingly, when biphase-mark-encoded sending data which is output from a vehicle-mounted apparatus or the like is sent to an in-vehicle network as it is, the influence of electromagnetic radiation which is released outside cannot be ignored even when a twisted pair cable is used as a transmission medium which has a low possibility of exerting an influence on the outside.

In order to solve this problem, it is conceivable to map each 2 bits of the sending data which is output from the MOST controller 91 to a predetermined signal level as one symbol for transmission (for example, see PCT International Publication No. 02/30075 pamphlet (FIG. 16 and FIG. 17)).

FIG. 21 shows an exemplary structure of a sending and receiving device for transmitting a MOST frame via a twisted pair cable. In FIG. 21, a MOST frame (serial data) which is output from the MOST controller 91 is converted into parallel data in units of 2 bits by an s/p conversion section 97. An octonary mapping section 98 maps 2-bit data which is sequentially output from the s/p conversion section 97 to a predetermined signal level as one symbol. (More accurately, the octonary mapping section 98 maps each symbol to a change amount from the immediately previous symbol, but this will not be described in detail here.) FIG. 22 shows an exemplary result of processing performed by the octonary mapping section 98. The result of processing performed by the octonary mapping section 98 is converted into an analog signal by a D/A conversion section 99 and then is output to a twisted pair cable 105 via a differential driver 100. Although not shown, the sending and receiving device 96 includes a digital filter such as a roll-off filter or the like on a stage after the octonary mapping section 98, and also includes an analog filter on, for example, a stage after the D/A conversion section 99.

On the other hand, a differential receiver 104 receives an input signal from another data transmission device via a twisted pair cable 106. This receiving signal is input to an A/D conversion section 103 via the differential receiver 104 and is converted into a digital signal. The output data from the A/D conversion section 103 is supplied to an octonary determination section 102, and each symbol is converted into 2-bit parallel data based on the signal level thereof. The parallel data which is output in units of 2 bits from the octonary determination section 102 is converted into serial data by a p/s conversion section 101 and is input to the MOST controller 91. The MOST controller 91 outputs receiving data based on the input MOST frame.

As described above, by mapping each 2 bits of the sending data which is output from the MOST controller 91 to a predetermined signal level as one symbol for transmission, the symbol rate can be suppressed to half of the symbol rate in the case where 1 bit is transmitted as one symbol, and thus the electromagnetic radiation can be reduced. As shown in FIG. 22, by performing mapping such that the polarity of the signal level is constantly inverted on a symbol by symbol basis, the sending signal always includes a frequency component which is half of the frequency of the symbol. Therefore, the apparatus on the receiving side can guarantee clock recovery with higher certainty by PLL (Phase Lock Loop).

### DISCLOSURE OF THE INVENTION

However, when 2-bit information is transmitted as one symbol by the mapping shown in FIG. 22, each symbol is mapped to either one of 8 signals (hereinafter, such mapping will be referred to as “octonary mapping”), which causes a problem that the interval between thresholds for determining the signal level on the receiving side is narrowed and thus transmission errors easily occur.

Accordingly, the present invention has an object of providing a data sending device, a data receiving device and a data transmission method capable of reducing electromagnetic radiation and decreasing transmission errors when sending or receiving biphase-mark-encoded sending data.

To achieve the above object, the present invention has the following aspects. The reference numerals and the like in the parentheses indicate the correspondence with the embodiments described later in order to help the understanding of the present invention, and do not limit the scope of the present invention in any way.

A data sending device (10) according to the present invention generates and outputs a sending signal based on biphase-mark-encoded sending data, and comprises a biphase decoding section (12) for biphase-mark-decoding the sending data; and a sending section (14) for generating and outputting the sending signal based on output data from the biphase decoding section. Thus, when sending or receiving biphase-mark-encoded sending signal, electromagnetic radiation can be further reduced and also transmission errors can be further decreased.

A vehicle-mounted apparatus according to the present invention has a biphase mark encoding function and includes the above-described data sending device. Thus, when sending or receiving biphase-mark-encoded sending signal, electromagnetic radiation can be further reduced and also transmission errors can be further decreased without changing the biphase mark encoding function of the vehicle-mounted apparatus.

A data receiving device (22) according to the present invention generates and outputs receiving data based on a receiving signal, and comprises a receiving section (26) for receiving the receiving signal; and a biphase encoding section (24) for generating the receiving data by biphase-mark-encoding output data from the receiving section and outputting the receiving data. Thus, when sending or receiving biphase-mark-encoded sending signal, electromagnetic radiation can be further reduced and also transmission errors can be further decreased.

A vehicle-mounted apparatus according to the present invention has a biphase mark decoding function and includes the above-described data receiving device. Thus, when sending or receiving biphase-mark-encoded sending signal, electromagnetic radiation can be further reduced and also transmission errors can be further decreased without changing the biphase mark decoding function of the vehicle-mounted apparatus.

A data transmission method according to the present invention is for transmitting biphase-mark-encoded sending data. According to the method, the sending data is biphase-mark-decoded and then sent on a sending side; and the sending data is reproduced by biphase-mark-encoding receiving data on a receiving side. Thus, when sending or receiving biphase-mark-encoded sending signal, electromagnetic radiation can be further reduced and also transmission errors can be further decreased, without changing the function of the apparatus on the sending side of generating the sending data by biphase-mark-encoding the original data to be transferred, or the function of the apparatus on the receiving side of reproducing the original data by biphase-mark-decoding receiving data.

### BRIEF DESCRIPTION OF THE DRAWINGS

FIG. 1 is a block diagram showing a structure of a data sending device according to one embodiment of the present invention.

FIG. 2 is a diagram showing the input/output relationship of a biphase decoding section 12.

FIG. 3 is a block diagram showing a structure of a sending section 14.

FIG. 4 is a diagram illustrating an operation of a quaternary mapping section 16.

FIG. 5 is a diagram illustrating an operation of the quaternary mapping section 16.

FIG. 6 shows a mapping table which is referred to by the quaternary mapping section 16.

FIG. 7 is a block diagram showing a structure of a data receiving section according to one embodiment of the present invention.

FIG. 8 is a block diagram showing a structure of a receiving section 26.

FIG. 9 is a diagram illustrating an operation of a difference calculation section 30.

FIG. 10 is a diagram illustrating an operation of a quaternary determination section 28.

FIG. 11 is a diagram showing the input/output relationship of a biphase encoding section 24.

FIG. 12 is a diagram showing a frame structure according to the S/PDIF.

FIG. 13 shows one example of a mapping table for a header section.

FIG. 14 is a diagram showing the signal level of each symbol when each header is mapped.

FIG. 15 is another diagram showing the signal level of each symbol when each header is mapped.

FIG. 16 is a diagram showing a waveform of a sending signal including a header section mapped based on the mapping table in FIG. 13.

FIG. 17 shows one example of a conversion table for a header section.

FIG. 18 is a diagram illustrating biphase mark encoding.

FIG. 19 is a diagram showing a structure of an S/PDIF frame.

FIG. 20 is a diagram showing a structure of a conventional sending and receiving device for sending and receiving a MOST frame via an optical fiber.

FIG. 21 is a diagram showing a structure of a conventional sending and receiving device for sending and receiving a MOST frame via a conductor.

FIG. 22 is a diagram illustrating octonary mapping.

### BEST MODE FOR CARRYING OUT THE INVENTION

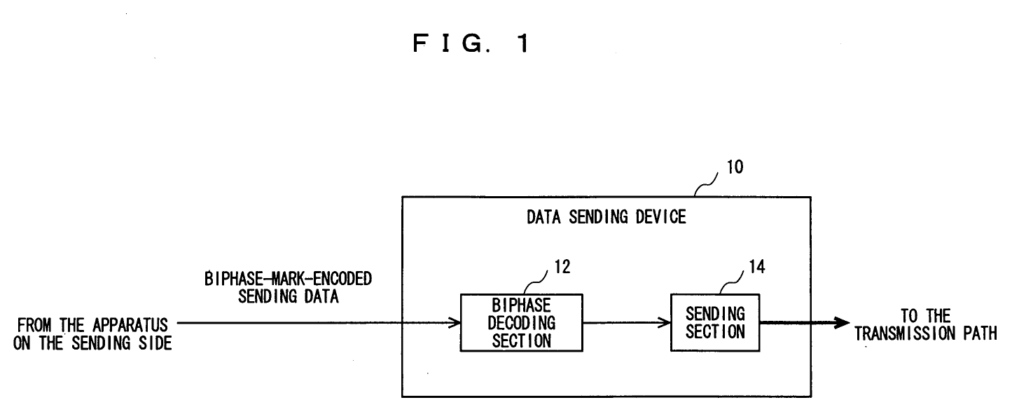

Hereinafter, a data sending device and a data receiving device according to one embodiment of the present invention will be described with reference to the drawings. FIG. 1 shows a structure of the data sending device. In FIG. 1, a data sending device 10 receives input biphase-mark-encoded sending data which is output from an apparatus on the sending side (not shown). The data sending device 10 includes a biphase decoding section 12 for biphase-mark-decoding the input sending data, and a sending section 14 for converting the output data from the biphase decoding section 12 into an electric signal suitable to be output to a transmission path. The electric signal generated in the sending section 14 is transmitted as a sending signal via a conductor such as a twisted pair cable. Here, the sending section 14 is described as outputting an electric signal, but the present invention is not limited to this. The sending section may output an optical signal. The biphase-mark-encoded sending data which is input from the apparatus on the sending side to the data sending device 10 may also be an optical signal.

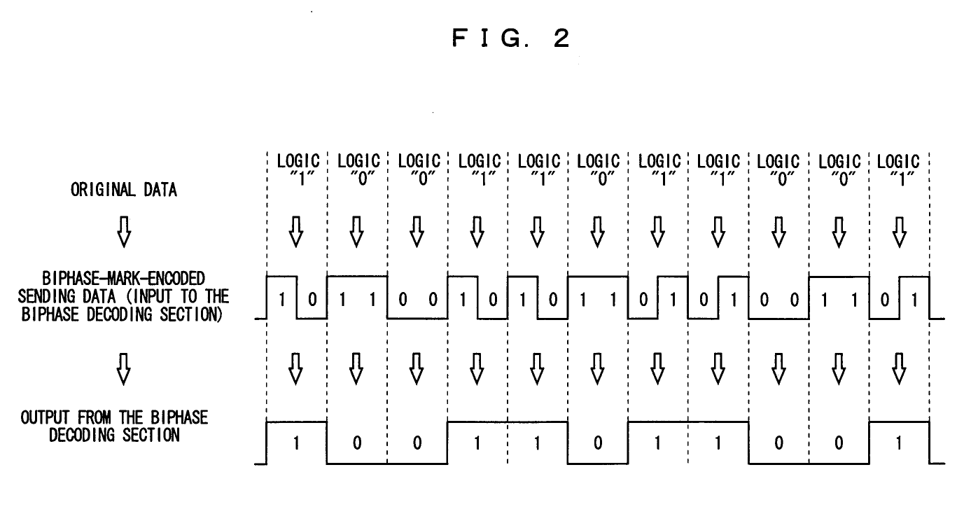

FIG. 2 shows the input/output relationship of original data and the biphase decoding section 12. The apparatus on the sending side has a function of biphase-mark-encoding the data to be transferred to an apparatus on the receiving side (original data) and outputting the data. The biphase decoding section 12 biphase-mark-decodes sending data which has been biphase-mark-encoded by the apparatus on the sending side. As a result, as shown in FIG. 2, the output data from the biphase decoding section 12 corresponds to the original data.

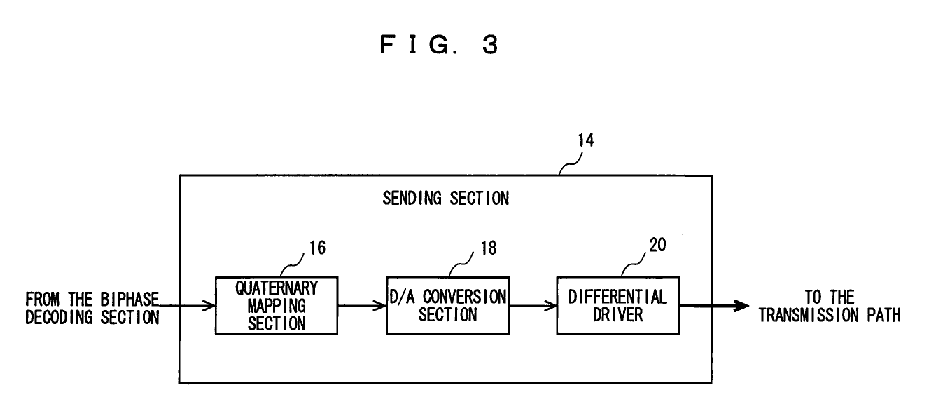

FIG. 3 shows a structure of the sending section 14. It should be noted that FIG. 3 merely shows one example of the structure of the sending section 14, which is usable in the case where each bit of the output data from the biphase decoding section 12 is sequentially mapped to any one of predetermined four signal levels as one symbol and the obtained signals are difference-transmitted using a twisted pair cable (i.e., the signals, the polarities of which are inverted with respect to each other, are transmitted via a pair of cables of the twisted pair cable).

In FIG. 3, the sending section 14 includes a quaternary mapping section 16 for performing quaternary mapping on the output data from the biphase decoding section 12 (this processing will be described later in detail), a D/A conversion section 18 for converting a digital signal which is output from the quaternary mapping section 16 into an analog signal, and a differential driver section 20 for sending symmetrical signals to the pair of cables of the twisted pair cable based on the post-D/A conversion signal. Although not shown, a digital filter such as a roll-off filter or the like is provided on a stage after the quaternary mapping section 16, and an analog filter is adequately provided on, for example, a stage after the D/A conversion section 18.

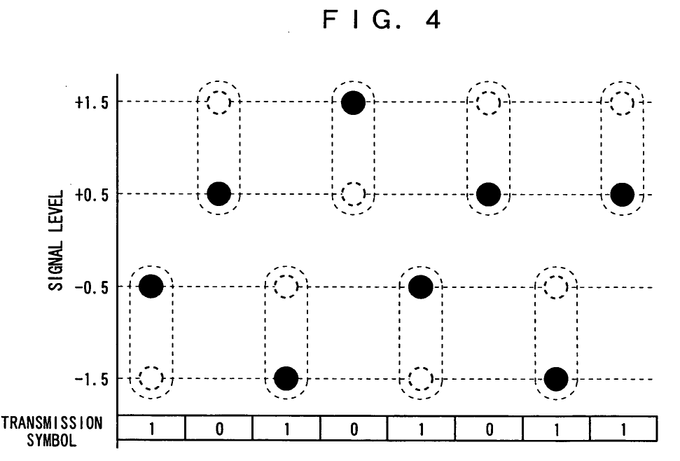

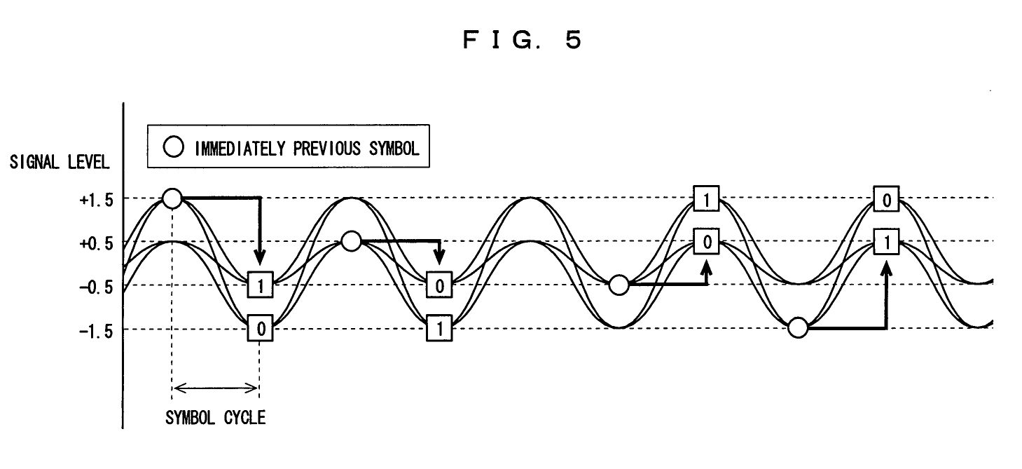

With reference to FIG. 4 and FIG. 5, an operation of the quaternary mapping section 16 will be described.

The quaternary mapping section 16 maps each symbol of the output data from the biphase decoding section 12 (here, 1-bit data) sequentially to any one of four signal levels as shown in FIG. 4 (+1.5, +0.5, −0.5, −1.5). The values of these signal levels are merely exemplary. The four signal levels are classified into an upper level (+1.5, +0.5) and a lower level (−0.5, −1.5) with a reference level (here, level 0) as the border. Each symbol of the sending data is mapped alternately to the upper level and the lower level. This mapping is performed in accordance with a mapping table held by the quaternary mapping section 16. As shown in FIG. 5, the quaternary mapping section 16 determines the signal level based on the sign of the symbol to be mapped and the signal level of the symbol immediately before the symbol to be mapped. For example, when the sign of the symbol to be mapped is 1 and the signal level of the symbol immediately therebefore is +1.5, the symbol to be mapped is mapped to the signal level of −0.5 (see FIG. 5).

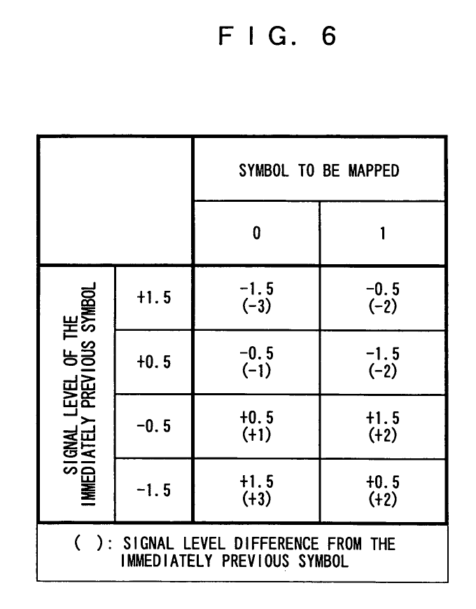

FIG. 6 shows a specific example of the mapping table held by the quaternary mapping section 16. In the mapping table shown in FIG. 6, the numerals in the parentheses each show a difference from the signal level of the immediately previous symbol. In the data receiving device described later, pre-mapping data is reproduced based on the difference. In more detail, when the difference from the signal level of the immediately previous symbol is any one of −3, −1, +1, and +3, the sending data can be determined as being 0. When the difference from the signal level of the immediately previous symbol is either −2 or +2, the sending data can be determined as being 0. By transmitting data in relation with the signal level difference between two consecutive symbols, the signal level acting as a reference (for example, the ground level) is not required when reproducing the data. This is especially effective when the signal level acting as a reference is different between the data sending device and the data receiving device. The present invention is not limited to this, and, for example, symbol 0 may be mapped to the signal level of +0.5 or −0.5 whereas symbol 1 may be mapped to the signal level of +1.5 or −1.5, regardless of the signal level of the immediately previous symbol. Alternatively, symbol 0 and symbol 1 may be mapped respectively to binary levels, regardless of the signal level of the immediately previous symbol.

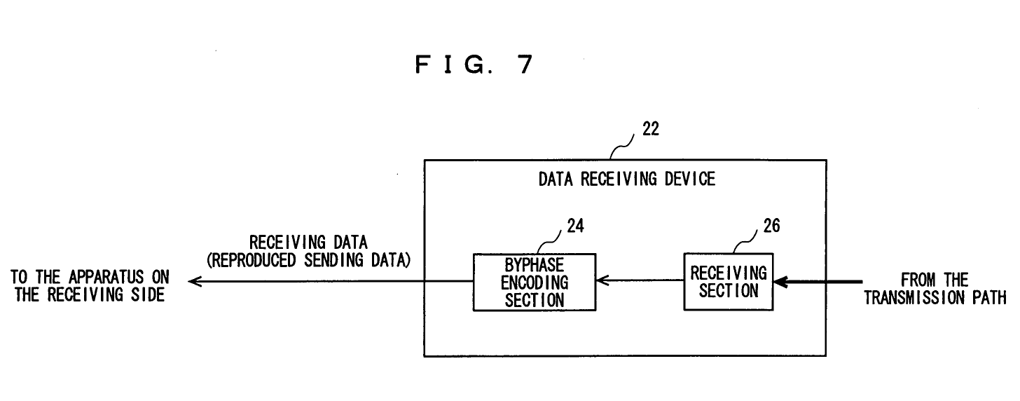

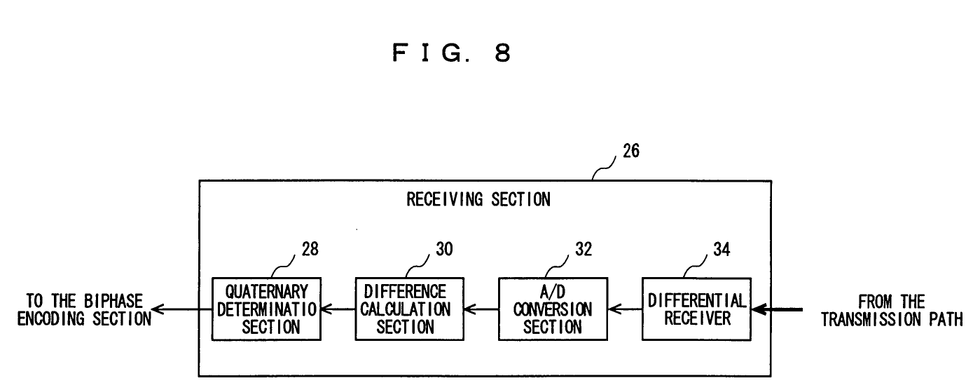

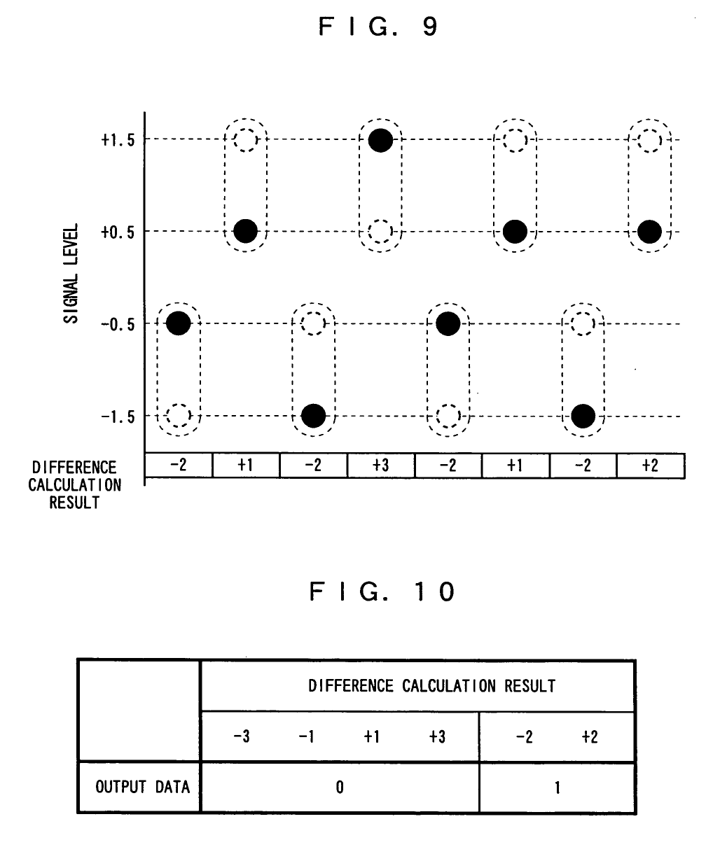

FIG. 7 shows a structure of the data receiving device. In FIG. 7, a data receiving device 22 includes a biphase encoding section 24 and a receiving section 26. The receiving section 26 receives an input signal which is sent from the data sending device 10 shown in FIG. 1 via the twisted pair cable. FIG. 8 shows an exemplary structure of the receiving section 26. A differential receiver 34 outputs a difference between the signals transmitted by the two cables of the twisted pair cable, and this output is converted into a digital signal by an A/D conversion section 32. The output data from the A/D conversion section 32 is input to a difference calculation section 30. The difference calculation section 30 sequentially calculates and outputs a signal level difference between each current symbol and a symbol immediately before the current symbol. FIG. 9 shows the relationship between the receiving signal and the calculation result of the difference calculation section 30. The calculation result of the difference calculation section 30 is input to a quaternary determination section 28.

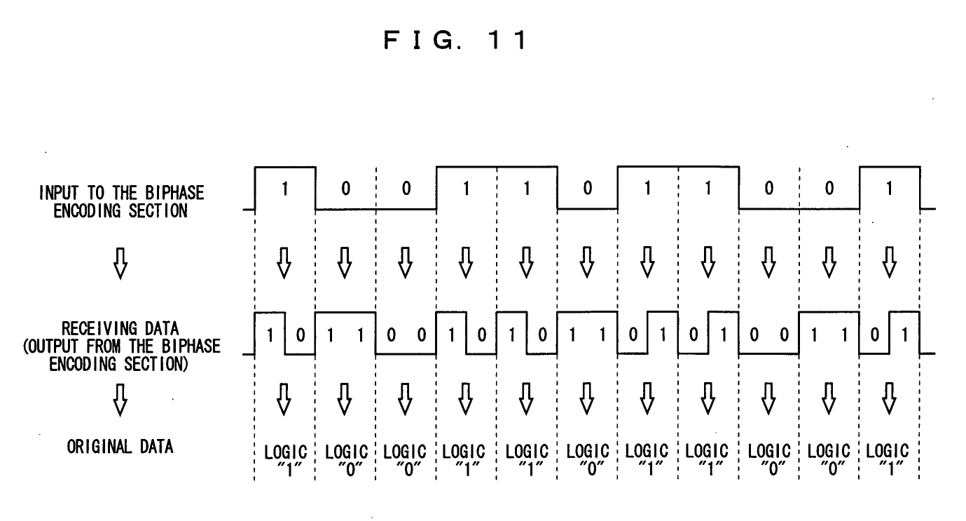

The quaternary determination section 28 sequentially converts the difference calculation result into the sign of 0 or 1, referring to a conversion table shown in FIG. 10, and outputs the resultant data. In more detail, when the difference calculation result is anyone of −3, −1, +1, and +3, the quaternary determination section 28 outputs 0. When the difference calculation result is either 31 2 or +2, the quaternary determination section 28 outputs 1. In this manner, data is sequentially output from the quaternary determination section 28.

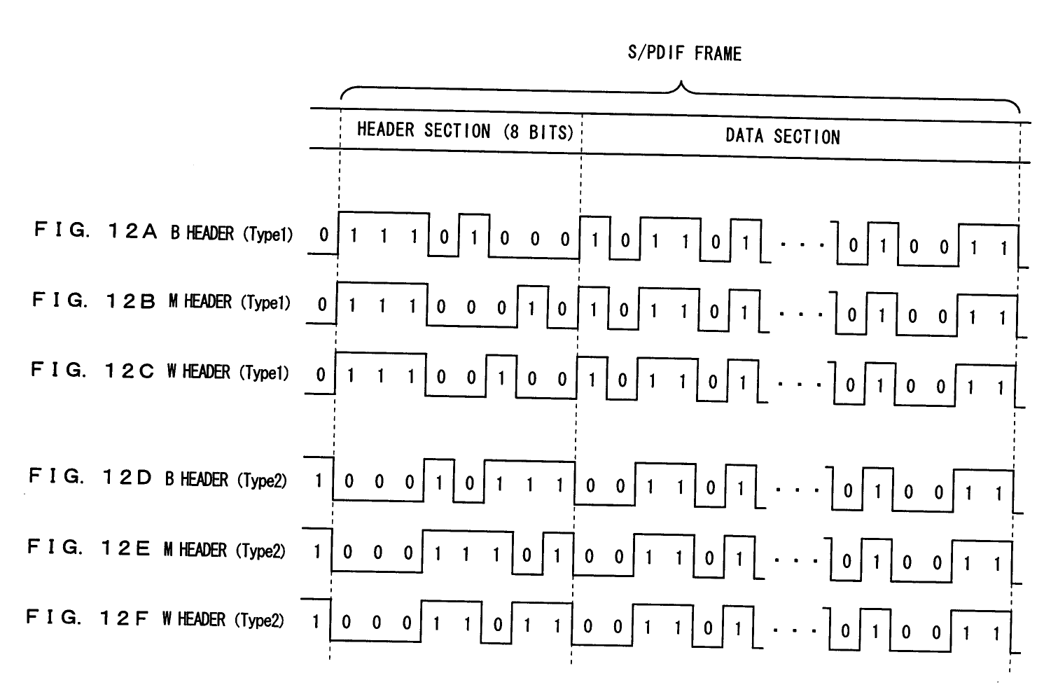

The output data from the quaternary determination section 28 is input to the biphase encoding section 24 shown in FIG. 7. As shown in FIG. 11, the biphase encoding section 24 biphase-mark-encodes the input data and outputs the resultant data to the apparatus on the receiving side (not shown). The output from the biphase encoding section 24 corresponds to the input to the biphase decoding section 12 shown in FIG. 1. The apparatus on the receiving side has a biphase mark decoding function, and can reproduce the original data based on the output data from the biphase encoding section 24.

As described above, according to this embodiment, the biphase-mark-encoded sending data is biphase-mark-decoded and then is transmitted. By this, the transmission bit rate which is required for achieving a predetermined effective transfer rate can be suppressed to half. As a result, even when sending or receiving, for example, biphase-mark-encoded sending data, electromagnetic radiation can be further reduced and also transmission errors can be further decreased. This is very effective for the case where data transfer is performed using a conductor such as a twisted pair cable or the like between vehicle-mounted apparatuses because the influence of the electromagnetic radiation is a serious problem in an in-vehicle environment. In addition, the further reduction of the electromagnetic radiation and the further decrease of the transmission errors can be realized without requiring any special change in the structure of the currently existing apparatus on the sending side or the currently existing apparatus on the receiving side.

According to this embodiment, the data sending device and the data receiving device respectively have only the data sending function and only the data receiving function. Alternatively, these devices may be structured as a data sending and receiving device having both the data sending function and the data receiving function.

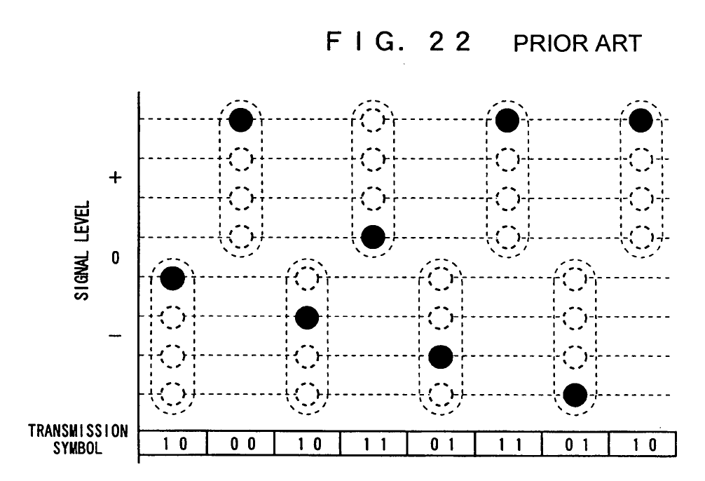

In this embodiment, the sending section 14 performs quaternary mapping. The present invention is not limited to this, and arbitrary mapping can be adopted, for example, octonary mapping shown in FIG. 2. It is preferable, though, to adopt a mapping system which allows a clock signal to be easily recovered from the receiving signal on the receiving side (for example, a mapping system as shown in FIG. 4 or FIG. 22, by which a higher/lower relationship of the signal level of each symbol with respect to a reference level; i.e., whether the signal level of each symbol is higher or lower than the reference level, is constantly inverted on a symbol by symbol basis), such that the clock signal does not need to be separately sent from the sending side to the receiving side. By this, the effects of the present invention can be provided without spoiling one of the advantages of data transfer using biphase mark encoding (the advantage that a clock signal can be easily recovered from the receiving signal on the receiving side).

In this embodiment, the apparatus on the sending side and the data sending device are independent from each other. The present invention is not limited to this. For example, the data sending device may be incorporated in the apparatus on the sending side. This is also applicable to the apparatus on the receiving side and the data receiving device.

As shown in FIG. 19, according to the S/PDIF, data transfer is performed on a frame by frame basis, and biphase mark encoding is applied to the data section. As described above, biphase mark encoding is not applied to the header section of an S/PDIF frame. Accordingly, when the present invention is applied to an S/PDIF system, the header section cannot be decoded by the biphase decoding section 12. Therefore, needless to say, a measure is required such as, for example: transmitting the header section and the data section separately from the data sending device to the data receiving device; adding data corresponding to the header section to the data section which is output from the biphase decoding section 12; or mapping the header section in accordance with a mapping table which is different from the mapping table used for the data section.

Hereinafter, an exemplary data transfer operation in the case where the header section is mapped in accordance with a mapping table which is different from the mapping table used for the data section will be described.

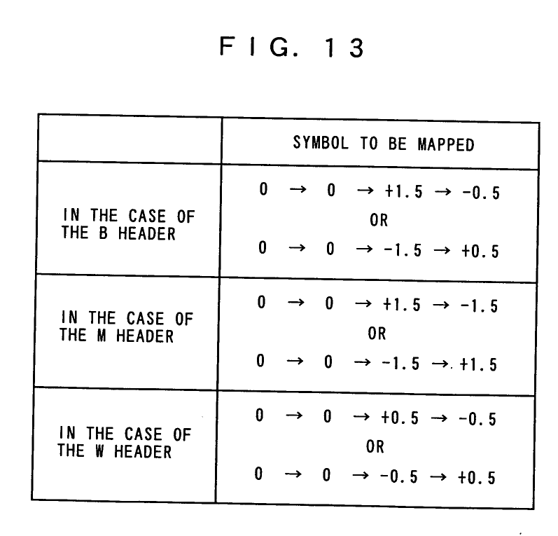

FIG. 12 shows a frame structure according to the S/PDIF. As shown in FIG. 12, the S/PDIF defines three types of headers (a B header, an M header, and a W header). For each type of header, two types of header structures are defined in accordance with the value of the data immediately before the header section. Specifically, for the case where the value of the data immediately before the header section is 0, header structures (a), (b) and (c) are defined; and for the case where the value of the data immediately before the header section is 1, header structures (d), (e) and (f) are defined.

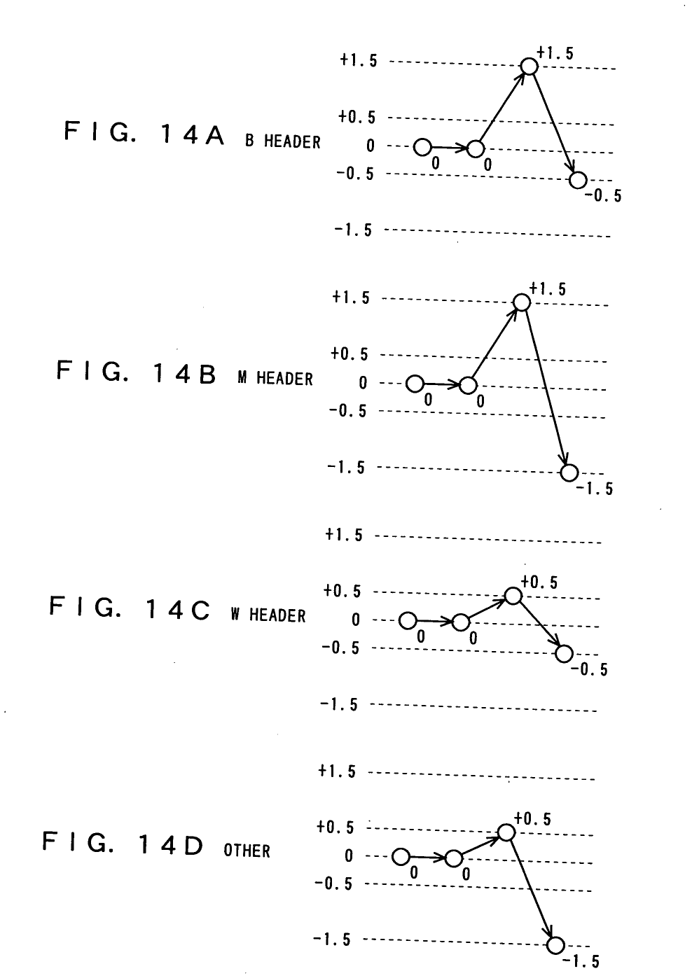

In the data sending section, the biphase decoding section 12 shown in FIG. 1 performs pattern matching of the above-mentioned header structures (a), (b) and (c) or (d), (e) and (f) shown in FIG. 12 with the sending data which is input from the apparatus on the sending side, and thus identifies the B header, the M header, and the W header. When the headers are identified, the quaternary mapping section 16 shown in FIG. 3 performs mapping of the header section, using a mapping table for the header section, which is different from the mapping table for the data section. FIG. 13 shows one example of the mapping table for the header section. This mapping table defines the mapping, by which the header section is mapped to a total of four symbols, signal level 0 is repeated by the first two symbols, and three types of headers are distinguished by the following two symbols. For example, in the case of the B header, “0, 0, +1.5, −0.5” or “0, 0, −1.5, +0.5” are sequentially mapped. Here, when the signal level of the symbol which is mapped immediately before the header section is higher than the reference level, “0, 0, −1.5, +0.5” are mapped; and when the signal level of the symbol which is mapped immediately before the header section is lower than the reference level, “0, 0, +1.5, −0.5” are mapped. The reason is that, as described above, according to this mapping system, it is preferable that the higher/lower relationship of the signal level of each symbol with respect to the reference level is constantly inverted on a symbol by symbol basis in order to realize easier recovery of a clock signal, and it is preferable that the order of the higher/lower relationship is maintained for the symbols of data sections which sandwich the four symbols of the header section. Specifically, it is preferable that when the signal level of the symbol which is mapped immediately before the header section is higher than the reference level, the symbol immediately after the header section is mapped to a signal level lower than the reference level; and that when the signal level of the symbol which is mapped immediately before the header section is lower than the reference level, the symbol immediately after the header section is mapped to a signal level higher than the reference level. Thus, the last symbol of the header section (the fourth symbol) is mapped to a signal level higher than the reference level when the symbol immediately after the fourth symbol is to be mapped to a signal level lower than the reference level; and the last symbol of the header section (the fourth symbol) is mapped to a signal level lower than the reference level when the symbol immediately after the fourth symbol is to be mapped to a signal level higher than the reference level. By performing the mapping in this manner, for converting the symbol which is mapped immediately after the header section on the receiving side, the usual conversion table for the data section (FIG. 10) can be used. Therefore, this exemplary mapping table prepares two mapping patterns for each of the B, M and W headers, i.e., a pattern in which the last symbol of the header section (the fourth symbol) is mapped to a signal level higher than the reference level, and a pattern in which the last symbol of the header section (the fourth symbol) is mapped to a signal level lower than the reference level.

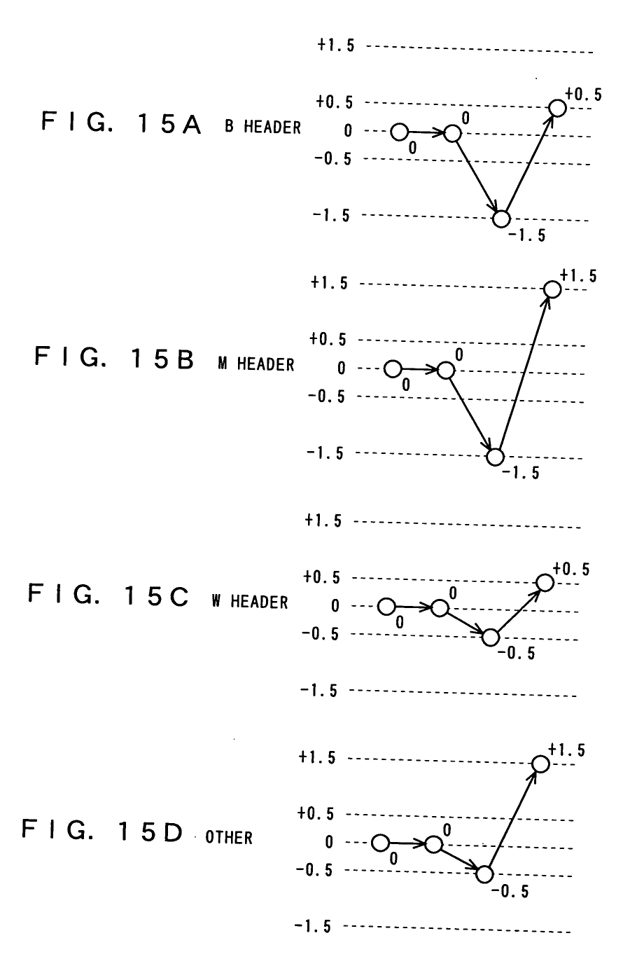

FIG. 14 shows the signal level of each symbol when each header is mapped in accordance with the mapping table shown in FIG. 13 in the case where the symbol immediately before the header section is mapped to a signal level lower than the reference level. The S/PDIF defines only three types of headers, but use of this mapping method allows more types of headers to be distinguished. Thus, for example, pattern (d) of FIG. 14 can be applied as the fourth type of header.

FIG. 15 shows the signal level of each symbol when each header is mapped in accordance with the mapping table shown in FIG. 13 in the case where the symbol immediately before the header section is mapped to a signal level higher than the reference level. In this case also, for example, pattern (d) of FIG. 15 can be applied as the fourth type of header.

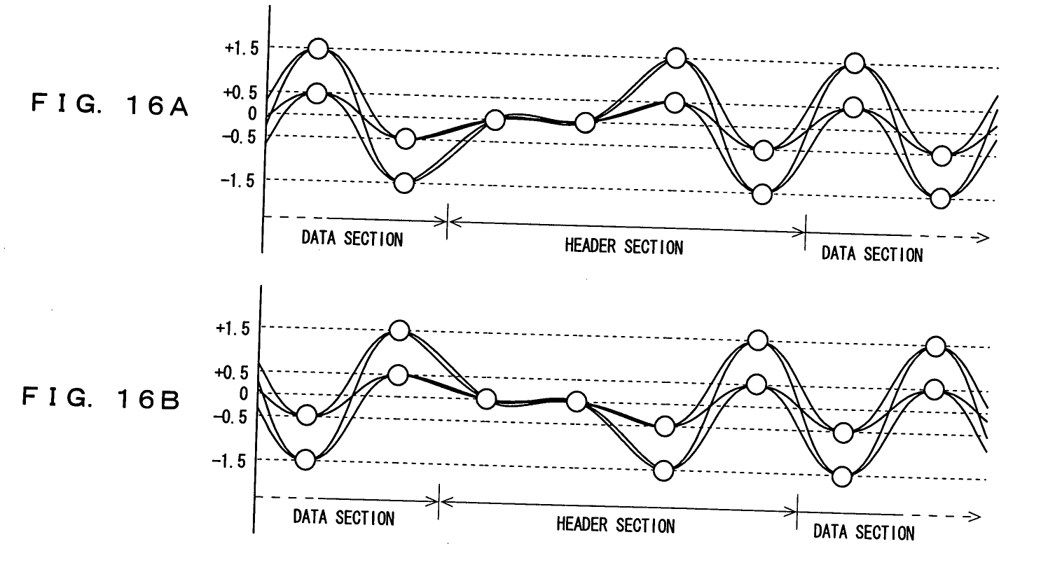

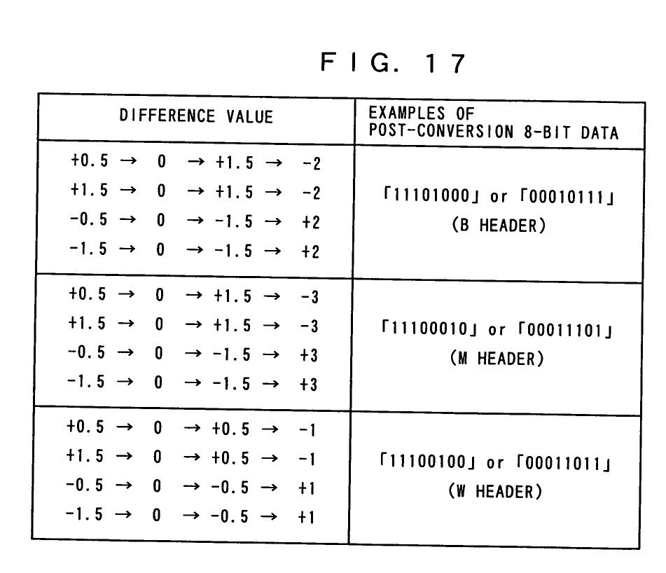

A sending signal including the header section mapped based on the mapping table shown in FIG. 13 has a waveform as shown in FIG. 16. In more detail, when the symbol immediately before the header section is mapped to a signal level higher than the reference level, the waveform is as shown in (b) of FIG. 16. When the symbol immediately before the header section is mapped to a signal level lower than the reference level, the waveform is as shown in (a) of FIG. 16.

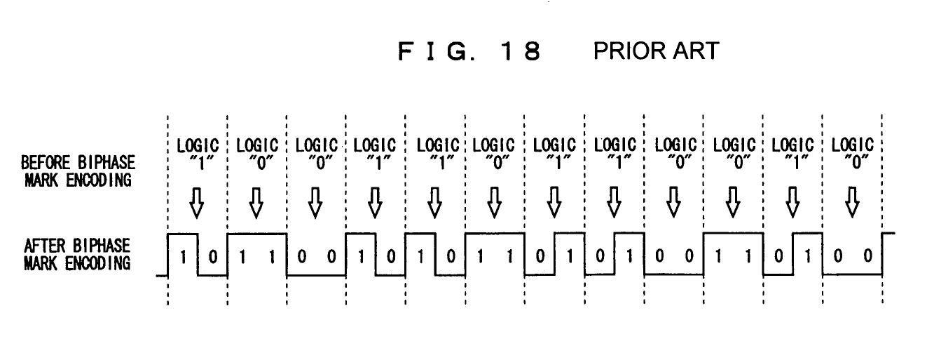

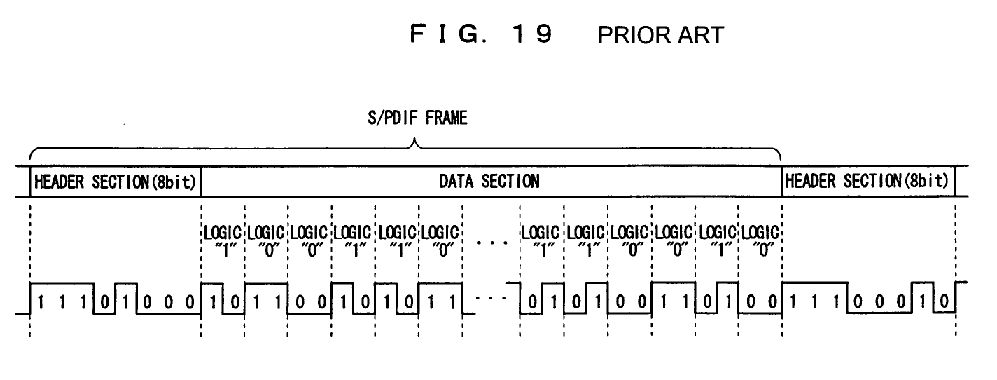

The data receiving section receives a receiving signal having a waveform shown in FIG. 16. When receiving a header section, the difference calculation section 30 in FIG. 8 identifies the header section from the difference value. The biphase encoding section 24 in FIG. 7 inserts a header section converted based on a conversion table shown in FIG. 17 at a position corresponding to the identified header section, thus generates receiving data, and outputs the receiving data to the apparatus on the receiving side. As described above, according to the S/PDIF, the B header, the M header and the W header each have two types of structures (a), (b) and (c) or (d), (e) and (f) based on the value of the data immediately previous thereto. Accordingly, the biphase encoding section 24 needs to change the post-conversion bit stream in accordance with whether the determined value of the data immediately before the header is 0 or 1. For example, the B header is converted into “11101000” when the determined value of the immediately previous data is 0, and into “00010111” when the determined value of the immediately previous data is 1.

As described above, by using a mapping table and a conversion table special for header sections, a header to which biphase mark is not applied, can be transmitted, and the present invention is applicable to such a header.

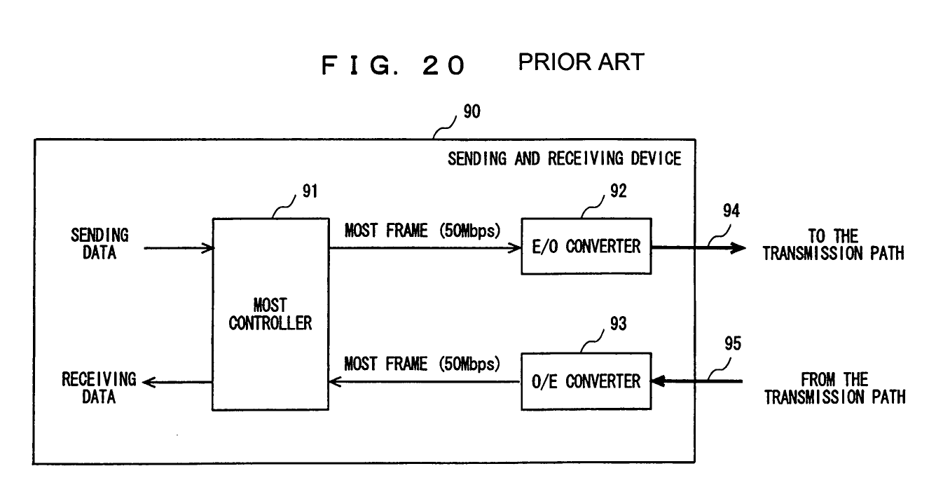

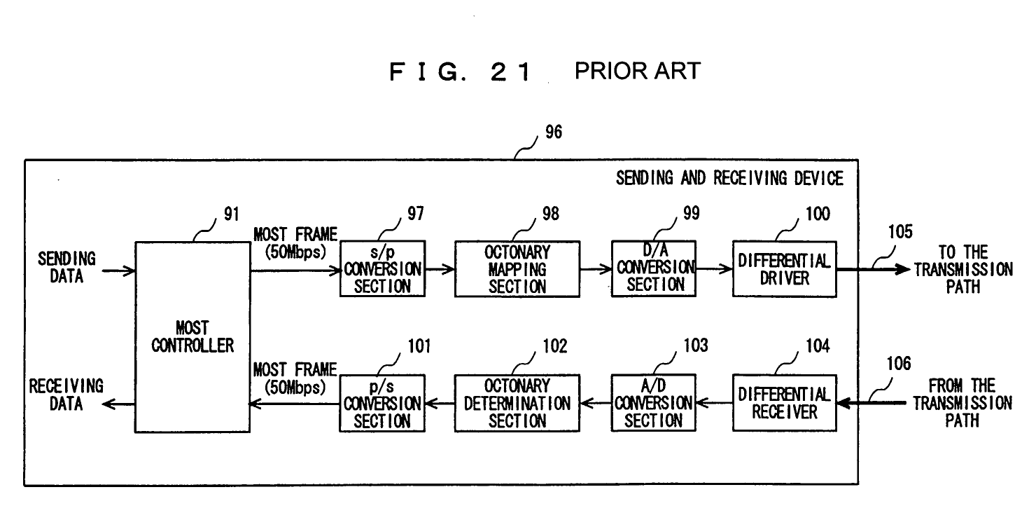

The present invention is applicable in substantially the same manner to a MOST system for transmitting data which has been biphase-mark-encoded as shown in FIG. 20.

### INDUSTRIAL APPLICABILITY

The present invention is preferable to a system of transferring biphase-mark-encoded data among a plurality of apparatuses in, for example, an in-vehicle LAN.

1. A data sending device for generating and outputting a sending signal based on biphase-mark-encoded sending data, the data sending device comprising:
a biphase decoding section for biphase-mark-decoding the sending data; and
a sending section for generating and outputting the sending signal based on output data from the biphase decoding section;
wherein:
the sending section includes a mapping section for mapping each symbol of the output data from the biphase decoding section to any one of a plurality of signal levels and generates the sending signal based on output data from the mapping section;
the sending data includes a data section to which biphase mark encoding is applied, and a non-data section to which the biphase mark encoding is not applied;
the biphase decoding section detects the non-data section; and
when the biphase decoding section detects the non-data section the mapping section maps the non-data section using a mapping table which is different from a mapping table used for the data section.

2. (canceled)

3. A data sending device according to claim 1, wherein the mapping section performs mapping such that a higher/lower relationship of the signal level of each symbol with respect to a reference level is constantly inverted on a symbol by symbol basis.

4. (canceled)

5. A vehicle-mounted apparatus, having a biphase mark encoding function and includes a data sending device according to claim 1.

6. A data receiving device for generating and outputting receiving data based on a receiving signal, the data receiving device comprising:
a receiving section for receiving the receiving signal; and
a biphase encoding section for generating the receiving data by biphase-mark-encoding output data from the receiving section and outputting the receiving data;
wherein:
the receiving signal includes a data section and a non-data section:
the receiving section detects the non-data section; and
when the receiving section detects the non-data section, the biphase encoding section converts the non-data section into a predetermined bit stream using a conversion table.

7. A data receiving device according to claim 6, wherein the receiving section includes a determination section for outputting data in accordance with a signal level of each symbol of the receiving signal.

8. (canceled)

9. A data receiving device according to claim 6, wherein the receiving section generates the output data based on a clock signal recovered from the receiving signal.

10. A vehicle-mounted apparatus, having a biphase mark decoding function and includes a data receiving device according to claim 6.

11. A data transmission method for transmitting sending data including a data section to which biphase mark encoding is applied and a non-data section to which the biphase mark encoding is not applied the data transmission method comprising the steps of:
biphase-mark-decoding the data section of the sending data and mapping each symbol of a result of the biphase mark encoding to any one of a plurality of signal levels;
detecting the non-data section from the sending data and mapping the detected non-data section using a mapping table which is different from a mapping table used for the data section;
generating a sending signal based on a result of the mapping of the data section and the non-data section;
transmitting the generated sending signal;
receiving the transmitted sending signal as a receiving signal;
biphase-mark-encoding a part of the receiving signal corresponding to the data section; and
detecting a part of the receiving signal corresponding to the non-data section and converting the detected part into a predetermined bit stream using a conversion table.

12. A data sending and receiving device comprising a data sending section for generating and outputting a sending signal based on biphase-mark-encoded sending data, and a data receiving section for generating and outputting receiving data based on a receiving signal;
wherein:
the data sending section comprises:
a biphase decoding section for biphase-mark-decoding the sending data; and
a sending section for generating and outputting the sending signal based on output data from the biphase decoding section;
wherein:
the sending section includes a mapping section for mapping each symbol of the output data from the biphase decoding section to any one of a plurality of signal levels, and generates the sending signal based on output data from the mapping section;
the sending data includes a data section to which biphase mark encoding is applied, and a non-data section to which the biphase mark encoding is not applied;
the biphase decoding section detects the non-data section; and
when the biphase decoding section detects the non-data section, the mapping section maps the non-data section using a mapping table which is different from a mapping table used for the data section; and
the data receiving section comprises:
a receiving section for receiving the receiving signal; and
a biphase encoding section for generating the receiving data by biphase-mark-encoding output data from the receiving section and outputting the receiving data;
wherein:
the receiving signal includes a data section and a non-data section;
the receiving section detects the non-data section; and
when the receiving section detects the non-data section, the biphase encoding section converts the non-data section into a predetermined bit stream using a conversion table.
